(19) United States
(12) Patent Application Publication
(10) Pub. No.: US 2025/0278172 A1
(43) Pub. Date: Sep. 4, 2025

(54) METHOD FOR MULTIMEDIA RESOURCE INTERACTION, MEDIUM AND ELECTRONIC DEVICE

(71) Applicant: Beijing Youzhuju Network Technology Co., Ltd., Beijing (CN)

(72) Inventors: Jinming ZHANG, Beijing (CN); Jiahao YE, Beijing (CN); Wei CAI, Beijing (CN); Xue YAO, Beijing (CN); Kai HOU, Beijing (CN); Shengyan SHI, Beijing (CN); Hao YANG, Beijing (CN); Xiaomin SONG, Beijing (CN)

(21) Appl. No.: 19/066,148

(22) Filed: Feb. 27, 2025

(30) Foreign Application Priority Data
Feb. 29, 2024 (CN) 202410232637.7

(51) Int. Cl. G06F 3/0483

(52) U.S. Cl. CPC G06F 3/0483

(57) ABSTRACT

A method for multimedia resource interaction, a medium, and an electronic device are provided. The method includes displaying a multimedia resource including a target object, displaying an interactive element associated with the target object in the multimedia resource in response to the multimedia resource being displayed to a display node, and displaying a page associated with the interactive element in response to a trigger operation on the interactive element.

### CROSS-REFERENCE TO RELATED APPLICATION

This application claims the priority to and benefits of the Chinese Patent Application, No. 202410232637.7, which was filed on Feb. 29, 2024, and is hereby incorporated by reference in its entirety.

### TECHNICAL FIELD

The present disclosure relates to the field of computer technology, and in particular, to a method for multimedia resource interaction, a medium, and an electronic device.

### BACKGROUND

With the development of the mobile Internet, the user increasingly acquires information through a mobile terminal, especially through a video. In the related art, when playing a video, an application generally plays the video in a fixed manner, lacking interaction between a user and the played video.

### SUMMARY

This Summary section is provided to introduce concepts in a simplified form that are described in detail in the following Detailed Description section. This Summary section is not intended to identify key features or essential features of the claimed technical solution, nor is it intended to be used to limit the scope of the claimed technical solution.

At least one embodiment of the present disclosure provides a method for multimedia resource interaction, which includes:
displaying a multimedia resource, where the multimedia resource includes a target object;
displaying an interactive element associated with the target object in the multimedia resource in response to the multimedia resource being displayed to a display node; and
displaying a page associated with the interactive element in response to a trigger operation on the interactive element.

At least one embodiment of the present disclosure provides an apparatus for multimedia resource interaction, which includes:
a first display module configured to display a multimedia resource, where the multimedia resource includes a target object;
a second display module configured to display an interactive element associated with the target object in the multimedia resource in response to the multimedia resource being displayed to a display node; and
a third display module configured to display a page associated with the interactive element in response to a trigger operation on the interactive element.

At least one embodiment of the present disclosure provides a non-transitory computer-readable storage medium storing computer programs, where the computer programs, upon being executed by a processor, implements the steps of the method according to at least one embodiment of the present disclosure.

At least one embodiment of the present disclosure provides an electronic device, which includes:
at least one memory, storing computer programs; and
at least one processor, configured to execute the computer programs in the at least one memory to implement the steps of the method according to at least one embodiment of the present disclosure.

At least one embodiment of the present disclosure provides a computer program product including computer programs, where the computer programs, upon being executed by a processor, implement the steps of the method according to at least one embodiment of the present disclosure.

Other features and advantages of the present disclosure will be described in detail in the following Detailed Description section.

### BRIEF DESCRIPTION OF DRAWINGS

The above and other features, advantages and aspects of various embodiments of the present disclosure becomes more apparent when taken in conjunction with the drawings and with reference to the following detailed description. Throughout the drawings, the same or similar reference numerals refer to the same or similar elements. It should be understood that the drawings are schematic and that the components and elements are not necessarily drawn to scale. In the drawings:

FIG. 1 is a flowchart of a method for multimedia resource interaction according to at least one embodiment of the present disclosure;

FIG. 2 is a schematic diagram of a display page according to at least one embodiment of the present disclosure;

FIG. 3 is a schematic diagram of an anchor according to at least one embodiment of the present disclosure;

FIG. 4 is a schematic diagram of a search control according to at least one embodiment of the present disclosure;

FIG. 5 is a schematic diagram of a product zone page according to at least one embodiment of the present disclosure;

FIG. 6 is a schematic diagram of a purchase page according to at least one embodiment of the present disclosure;

FIG. 7 is a schematic diagram of an anchor according to at least one embodiment of the present disclosure;

FIG. 8 is a schematic diagram of a preset animation effect according to at least one embodiment of the present disclosure;

FIG. 9 is a schematic diagram of a naked-eye three-dimensional effect according to at least one embodiment of the present disclosure;

FIG. 10 is a structural schematic diagram of an apparatus for multimedia resource interaction according to at least one embodiment of the present disclosure; and

FIG. 11 is a structural schematic diagram of an electronic device according to at least one embodiment of the present disclosure.

### DETAILED DESCRIPTION

Embodiments of the present disclosure are described in more detail below with reference to the drawings. Although some embodiments of the present disclosure are shown in the drawings, it should be understood that the present disclosure can be implemented in various forms and should not be construed as being limited to the embodiments set forth herein. Rather, these embodiments are provided for a more thorough and complete understanding of the present disclosure. It should be understood that the drawings and embodiments of the present disclosure are only for exemplary purposes and are not intended to limit the scope of protection of the present disclosure.

It should be understood that the various steps described in the method implementations of the present disclosure may be performed in different orders and/or in parallel. In addition, the method implementations may include additional steps and/or omit performing the illustrated steps. The scope of the present disclosure is not limited in this regard.

The term “include/comprise” and its variations as used herein are open-ended inclusions, that is, “include/comprise but not limited to”. The term “based on” is “based at least in part on”. The term “an embodiment” means “at least one embodiment”; the term “another embodiment” means “at least one other embodiment”; and the term “some embodiments” means “at least some embodiments”. Relevant definitions of other terms will be given in the description below.

It should be noted that concepts such as “first” and “second” mentioned in the present disclosure are only used to distinguish different apparatuses, modules or units, and are not used to limit the order of functions performed by these apparatuses, modules or units or their interdependence.

It should be noted that the modifiers “a/an” and “a plurality of” mentioned in the present disclosure are illustrative and not restrictive, and those skilled in the art should understand that they should be understood as “one or more” unless the context clearly indicates otherwise.

The names of messages or information exchanged between apparatuses in the implementations of the present disclosure are only for illustrative purposes, and are not intended to limit the scope of these messages or information.

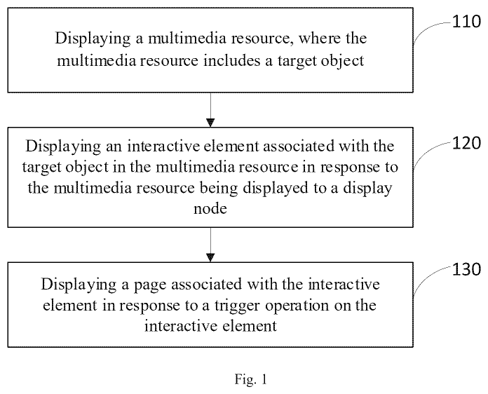

FIG. 1 is a flowchart of a method for multimedia resource interaction according to at least one embodiment of the present disclosure. As shown in FIG. 1, an embodiment of the present disclosure provides a method for multimedia resource interaction, which may be executed by an electronic device, and may specifically be executed by an apparatus for multimedia resource interaction, which may be implemented by software and/or hardware and configured in the electronic device. As shown in FIG. 1, the method may include the following steps.

In step 110, a multimedia resource is displayed, where the multimedia resource includes a target object.

Here, the multimedia resource may be a video, a carousel picture (that is, a picture group composed of multiple pictures), etc. Of course, the multimedia resource may also be an audio resource. The electronic device may display the multimedia resource through a display page of the multimedia resource. The display page of the multimedia resource may refer to a display interface in a multimedia resource program, which is used to display the multimedia resource. Taking a short video application as an example, the display page of the multimedia resource may be a playing interface in the short video program. The electronic device plays a short video in the playing interface of the short video application.

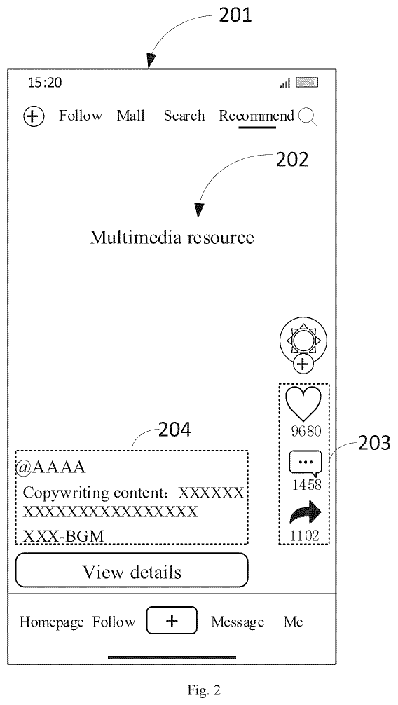

FIG. 2 is a schematic diagram of a display page according to at least one embodiment of the present disclosure. As shown in FIG. 2, a multimedia resource 202 is displayed in a display page 201. It should be understood that the display page may display the multimedia resource 202 through the entire page area or part of the page area of the display page 201. Of course, the display page 201 may also include a page element. The page element may include an interactive control 203, resource description information 204, etc. The interactive control 203 may refer to an element for receiving an interactive operation on the multimedia resource performed by a user. For example, the interactive control 203 is a like control for giving a like to the multimedia resource, a forward control for forwarding the multimedia resource, a comment control for commenting on the multimedia resource, etc. The resource description information 204 may refer to copywriting information for describing the multimedia resource and/or information for describing a publishing account of the multimedia resource, and the information of the publishing account may include an account name of the publishing account and/or an avatar used by the publishing account.

Of course, the display page 201 may also have controls for implementing other functions, such as controls for implementing a video capturing function, a video uploading function, a chatting function, and a following function, which will not be described in detail here.

The multimedia resource may include a target object, and the target object may refer to a main item or a main character in the multimedia resource. Taking the multimedia resource as an advertisement video as an example, the target object may refer to a product corresponding to the advertisement video. That is, the target object may be a product advertised in the advertisement video.

In step 120, an interactive element associated with the target object is displayed in the multimedia resource in response to the multimedia resource being displayed to a display node.

Here, the display node may refer to a resource node in the multimedia resource. Taking the multimedia resource as a video as an example, the display node of the multimedia resource refers to a video node corresponding to the video. For example, the display node of the multimedia resource may be the 10th second of the video, that is, in response to the multimedia resource being played to the 10th second, the interactive element associated with the target object is displayed in the multimedia resource.

It should be noted that for different multimedia resources, their corresponding display nodes may be different. Taking the multimedia resource as a video as an example, the display node may be dynamically set according to the total duration of the video.

The interactive element associated with the target object may be a control that can be used to interact with the user. It should be understood that the interactive element is associated with the target object in the multimedia resource, so that the user can jump to a page associated with the target object through the interactive element, or interact with the target object through the interactive element. In addition, the style of the interactive element may also be associated with the target object. That is, for different target objects, the style of the interactive element may be different.

In some embodiments, the interactive element may be an anchor. The anchor may be understood as a control that can perform a preset action. For example, when the user clicks the anchor, a page associated with the anchor may be jumped to.

It should be noted that the anchor may be displayed at a first preset position of the multimedia resource, and the first preset position may be any position in the multimedia resource, which may be specifically set according to actual conditions.

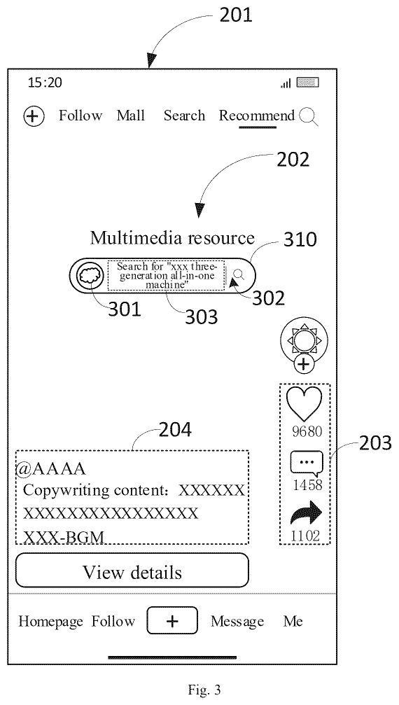

FIG. 3 is a schematic diagram of an anchor according to at least one embodiment of the present disclosure. As shown in FIG. 3, the anchor 310 may include a first image 301 corresponding to the target object, a search box 302, and a search word 303 associated with the target object. The first image 301 and the search word 303 may be located within the search box 302.

It should be understood that the first image 301 may be an image of the target object itself. Taking the target object as a product as an example, the first image 301 may be a product image corresponding to the product. The search word 303 may be a word for searching for the target object corresponding to the first image 301.

In some other embodiments, the interactive element may be a search control. The search control may be understood as a control that can perform a search action. For example, when the user searches for a corresponding search word through the search control, a page corresponding to the search word may be jumped to.

It should be noted that the search control may be displayed at a second preset position of the multimedia resource, and the second preset position may be any position in the multimedia resource, which may be specifically set according to actual conditions.

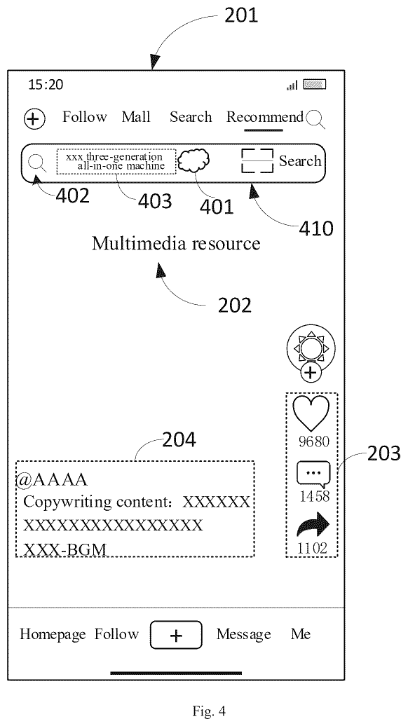

FIG. 4 is a schematic diagram of a search control according to at least one embodiment of the present disclosure. As shown in FIG. 4, the search control 410 may include a first image 401 corresponding to the target object, a search box 402, and a search word 403 associated with the target object. The first image 401 and the search word 403 may be located within the search box 402.

It should be understood that the first image 401 may be an image of the target object itself. Taking the target object as a product as an example, the first image 401 may be a product image corresponding to the product. The search word 403 may be a word for searching for the target object corresponding to the first image 401. It should be noted that a search word 403 associated with the target object may be preset in the search box 402, and the user may search for a page associated with the search word 403 based on the search word 403 by triggering the search function of the search control 410. Of course, the user may also search for other content by adjusting the search word corresponding to the search control 410, so that the user can search quickly without exiting the multimedia resource.

In step 130, a page associated with the interactive element is displayed in response to a trigger operation on the interactive element.

Here, the trigger operation on the interactive element may be a click operation. Of course, the trigger operation on the interactive element may also be other interactive types of operations, such as a touch-and-hold operation, a voice operation, a gesture operation, etc., which may be specifically set according to actual conditions. When the electronic device detects the trigger operation on the interactive element, the electronic device displays the page associated with the interactive element.

Exemplarily, the electronic device may jump from a display page of the multimedia resource to a page associated with the interactive element, so as to display the page associated with the interactive element.

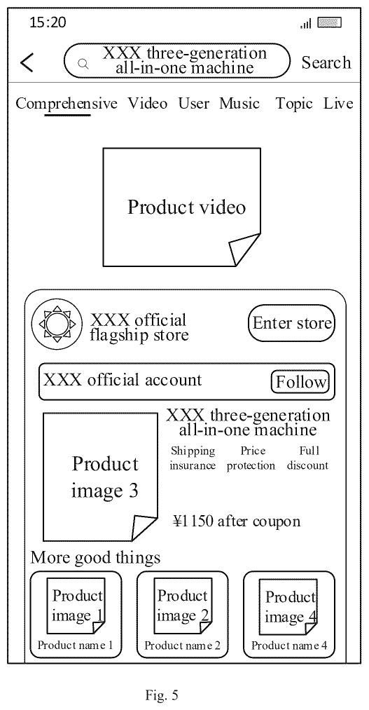

It should be noted that when the interactive element is an anchor, the page associated with the anchor may be a first page. Taking the target object as a product as an example, the first page associated with the anchor as the interactive element may be a product zone page corresponding to the product. FIG. 5 is a schematic diagram of a product zone page according to at least one embodiment of the present disclosure. As shown in FIG. 3 and FIG. 5, when the user clicks on the anchor 310 in FIG. 3, the electronic device displays a product zone page associated with the target object (such as “XXX three-generation all-in-one machine”) as shown in FIG. 5, and the user can obtain relevant information of the target object through the product zone page.

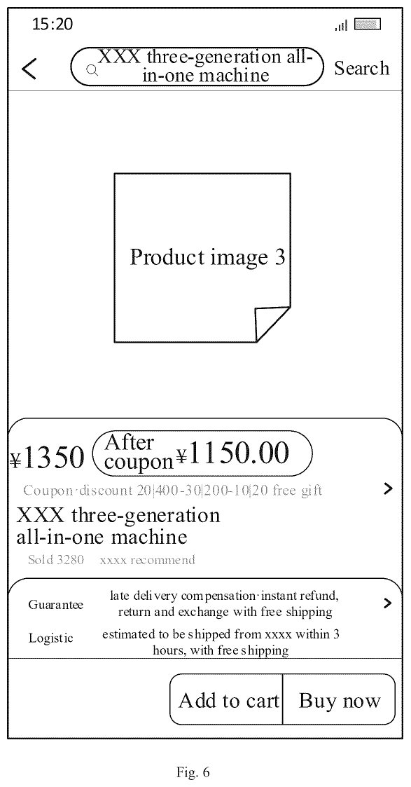

When the interactive element is a search control, the page associated with the search control may be a second page corresponding to a search word in the search control. Taking the target object as a product as an example, the second page associated with the search control as the interactive element may be a page corresponding to a search word for the product. Exemplarily, when the search word is the name of the product, the second page associated with the search control may be a purchase page of the product. FIG. 6 is a schematic diagram of a purchase page according to at least one embodiment of the present disclosure. As shown in FIG. 4 and FIG. 6, when the user clicks on the search control 410 in FIG. 4, the electronic device displays a purchase page associated with the search word (such as “XXX three-generation all-in-one machine”) as shown in FIG. 6, so that the user can purchase the target object through the purchase page.

It should be noted that the page associated with the interactive element may be set by a developer according to requirements, that is, the page associated with the interactive element may be different. Of course, in the embodiments of the present disclosure, the page associated with the interactive element may be a page associated with the target object, so that the user can obtain more relevant information of the target object displayed in the multimedia resource through the displayed page associated with the interactive element.

Therefore, by displaying a multimedia resource including a target object, and displaying an interactive element associated with the target object in the multimedia resource in response to the multimedia resource being displayed to a display node, and displaying a page associated with the interactive element in response to a trigger operation on the interactive element, a user can interact with the multimedia resource through the interactive element, and the experience of the user watching the multimedia resource is improved. In addition, by displaying the interactive element, the user can also obtain more information related to the multimedia resource through the interactive element, which greatly improves the information acquisition efficiency of the user.

In some implementations that may be implemented, the interactive element may include an anchor. Accordingly, in step 120, the anchor is displayed in the multimedia resource. Accordingly, in step 130, a first page associated with the anchor may be displayed in response to a first trigger operation on the anchor.

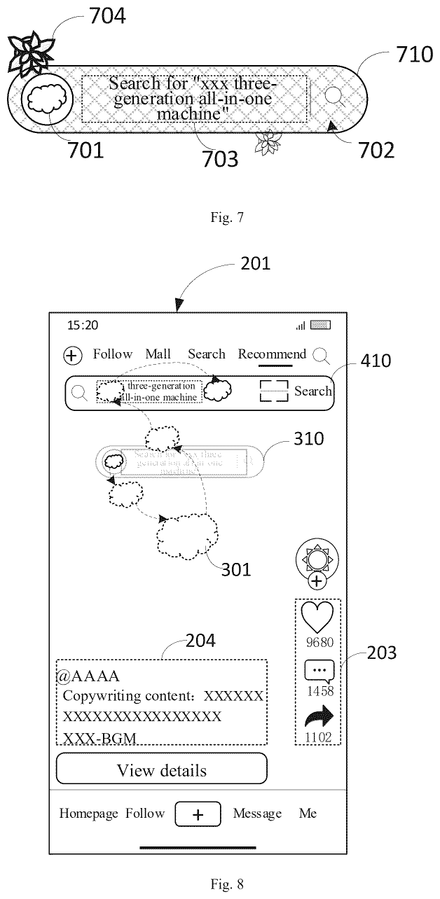

Here, the anchor may include at least one of a first image corresponding to the target object, a search box, a second image superimposed with the search box, and a search word associated with the target object. FIG. 7 is a schematic diagram of an anchor according to at least one embodiment of the present disclosure. As shown in FIG. 7, the anchor 710 may include a first image 701 corresponding to the target object, a search box 702, a second image 704 superimposed with the search box 702, and a search word 703 associated with the target object. The second image 704 may be a static image or a dynamic image. The second image 704 allows the developer to adjust the style of the anchor 710 by configuring different second images 704.

It should be understood that the second image 704 can not only increase the variety of styles of the anchor 710, but also highlight the anchor 710 to increase the usability of the anchor 710.

As shown in FIG. 3 and FIG. 5, when the multimedia resource is displayed to the display node, the electronic device displays the anchor 310 in the multimedia resource; and when the electronic device detects a first trigger operation on the anchor 310, the electronic device jumps to display the first page (product zone page) associated with the anchor 310 in response to the first trigger operation on the anchor 310.

It should be noted that the first trigger operation on the anchor may be a click operation, and of course, may also be other interactive types of operations described in the above embodiments.

Therefore, by displaying an anchor associated with the target object in the process of displaying the multimedia resource, the user may be prompted through the anchor to interact with the multimedia resource through the anchor, which can greatly increase the probability of interaction between the user and the multimedia resource.

In some implementations that may be implemented, a search control associated with the target object is displayed in the multimedia resource in response to not detecting the first trigger operation on the interactive element.

Here, the search control is configured to display a second page associated with the search control in response to a second trigger operation on the search control. The second trigger operation on the search control may be a click operation, and of course, may also be other interactive types of operations described in the above embodiments.

In some embodiments, the search control may include at least one of a first image corresponding to the target object, a search box, a second image superimposed with the search box, and a search word associated with the target object.

The first image, the search box, and the search word included in the search control may be referred to the related description of FIG. 4, which will not be repeated here. The second image superimposed with the search box included in the search control may be referred to the related description of the second image included in the anchor, and their concepts and functions are consistent, which will not be repeated here.

Exemplarily, the electronic device may display the search control in the multimedia resource in response to not detecting the first trigger operation on the anchor after the anchor is displayed for a preset time period.

That is, the electronic device displays the anchor first, and in response to the anchor not being triggered and reaching a preset time period, the anchor may be hidden and the search control is displayed. As shown in FIG. 3 and FIG. 4, the electronic device displays the anchor 310 in the multimedia resource 202; and in response to the anchor 310 not being triggered by the user after an interval of N seconds, the anchor 310 is hidden and the search control 410 is displayed, so that the user may search for content related to the target object through the search control 410.

As shown in FIG. 3 to FIG. 6, in response to the multimedia resource 202 being displayed to the display node, the electronic device displays the anchor 310 in the multimedia resource 202; and when the electronic device detects a first trigger operation on the anchor 310, the electronic device jumps to display the product zone page shown in FIG. 5 in response to the first trigger operation on the anchor 310. In response to the anchor 310 not being triggered all the time, the anchor 310 is hidden and the search control 410 is displayed after an interval of N seconds. In response to detecting a trigger operation on the search control 410, the purchase page shown in FIG. 6 is jumped to and displayed.

It should be noted that in response to not detecting the second trigger operation on the search control all the time, the search control may be hidden after a specific time interval; of course, in other implementations, the search control may be displayed all the time. When the user switches to display other multimedia resources, the display of the search control is stopped.

Therefore, by displaying the search control associated with the target object, the user can interact with the multimedia resource through the search control, and moreover, through the search control, the user can quickly search for content related to the multimedia resource through the search control without exiting the currently displayed multimedia resource, which improves the information search efficiency of the user.

In some implementations that may be implemented, the electronic device may display the search control in the multimedia resource through a preset animation effect.

Here, the preset animation effect is used to describe an animation effect of the anchor evolving into the search control. Exemplarily, the preset animation effect may be that the anchor at the first preset position of the multimedia resource gradually fades away, and the search control is gradually displayed at the second preset position of the multimedia resource after the anchor completely fades away, so as to reflect the effect of the anchor evolving into the search control through the effect of gradual fading and gradual display.

Of course, in some implementations that may be implemented, the anchor includes the first image corresponding to the target object. Correspondingly, the preset animation effect includes: the anchor at the first preset position gradually fading away, highlighting the first image through a zoom animation effect, moving the first image to the second preset position, and displaying the search control being the second preset position.

Highlighting the first image through the zoom animation effect may be to enlarge and display the first image first, and then reduce and display the first image. The first image that is enlarged and displayed may be gradually enlarged while moving on the multimedia resource, until the first image is enlarged to a first preset size and moved to a third preset position; and then the first image is reduced while moving from the third preset position, until the first image is reduced to a second preset size and moved to the second preset position. Then, the search control is displayed at the second preset position. It should be understood that the first image may be moved in the search box of the search control, and the search word associated with the search box is gradually displayed in the moving process.

FIG. 8 is a schematic diagram of a preset animation effect according to at least one embodiment of the present disclosure. As shown in FIG. 8, the first image 301 in the anchor 310 is gradually enlarged and displayed, and other elements (such as the search word, the search box, etc.) in the anchor 310 gradually fade away until disappearing. Then, the first image 301 is gradually reduced and moved to a second preset position for displaying the search control 410, and then the search control 410 is displayed; moreover, the first image is moved from a left side of the search box to a right side of the search box, and in the moving process, the search word of the search control 410 is gradually displayed, until all the search word is displayed, and the first image 301 stops moving.

It should be noted that by displaying the first image 301 in the above implementation, the display of search control 410 may be introduced by the first image 301, which reflects the process of the anchor 310 evolving into the search control 410, thereby prompting the user through a visual effect that the user can interact with the multimedia resource through the search control 410 to obtain more information about the target object.

In some implementations that may be implemented, the first image is a dynamic image, and accordingly, the preset animation effect further includes controlling the dynamic image to interact with a page element in the display page for displaying the multimedia resource, so as to cause the dynamic image to cooperate with the page element to form a naked-eye three-dimensional effect.

As shown in FIG. 2, the page element may include an interactive control 203, resource description information 204, etc. The first image may be a dynamic image, and the dynamic image may be a video or a GIF (Graphics Interchange Format) picture. It should be understood that the dynamic image may be a dynamic image of the target object uploaded by the developer. Taking the target object as a product as an example, the dynamic image may be a video for displaying the product at different angles and/or in different forms.

In the case that the first image is a dynamic image, the preset animation effect may include: the anchor at the first preset position gradually fading away, highlighting the dynamic image through the zoom animation effect, moving the dynamic image to the second preset position, and displaying the search control at the second preset position, and in the process of highlighting the dynamic image through the zoom animation effect and moving the dynamic image to the second preset position, the dynamic image being controlled to interact with the page element in the display page for displaying the multimedia resource, so as to cause the dynamic image to cooperate with the page element to form a naked-eye three-dimensional effect.

It should be noted that the dynamic image interacting with the page element to form the naked-eye three-dimensional effect may be that the dynamic image can at least partially block the page element in the display page, so that the dynamic image and the page element are superimposed and cooperate to form the naked-eye three-dimensional effect.

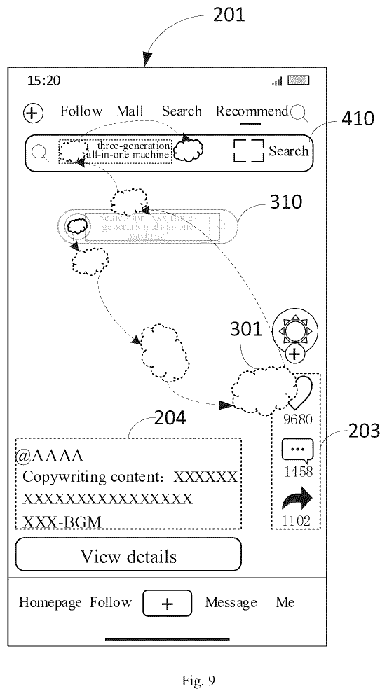

FIG. 9 is a schematic diagram of a naked-eye three-dimensional effect according to at least one embodiment of the present disclosure. As shown in FIG. 9, the first image 301 may block a like button in the interactive control 203, thereby forming a naked-eye three-dimensional effect that the first image 301 breaks the limited range of the multimedia resource and presents to the user.

Therefore, by displaying the search control through the above preset animation effect, the search control can be displayed with interesting effects, which greatly improves the user experience.

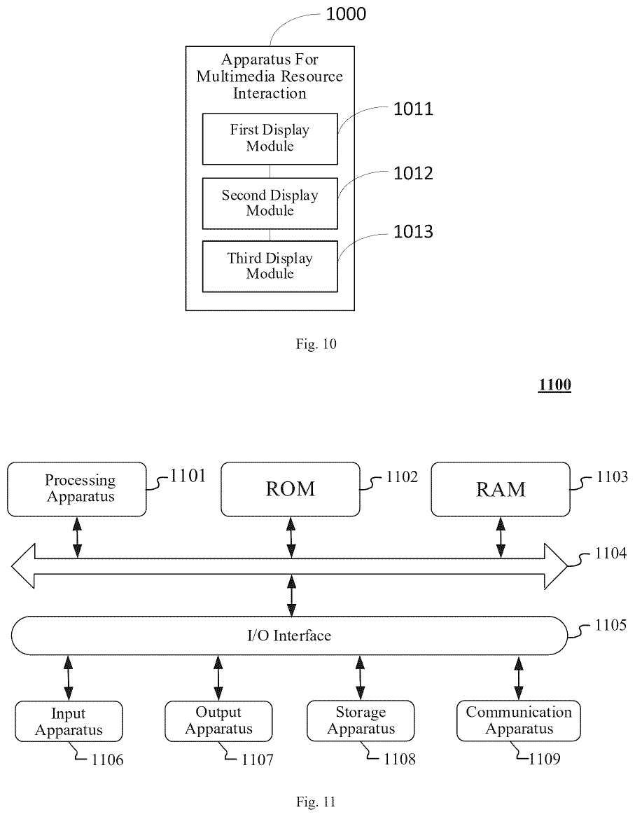

FIG. 10 is a structural schematic diagram of an apparatus for multimedia resource interaction according to at least one embodiment of the present disclosure. As shown in FIG. 10, an embodiment of the present disclosure provides an apparatus for multimedia resource interaction 1000, which includes:
a first display module 1011 configured to display a multimedia resource, where the multimedia resource includes a target object;
a second display module 1012 configured to display an interactive element associated with the target object in the multimedia resource in response to the multimedia resource being displayed to a display node; and
a third display module 1013 configured to display a page associated with the interactive element in response to a trigger operation on the interactive element.

Optionally, the interactive element includes an anchor, and the second display module 1012 is specifically configured to:
display the anchor in the multimedia resource; and
the third display module 1013 is specifically configured to:
display a first page associated with the anchor in response to a first trigger operation on the anchor.

Optionally, the apparatus for multimedia resource interaction 1000 further includes:
a fourth display module configured to display a search control associated with the target object in

the multimedia resource in response to not detecting the first trigger operation on the interactive element, where the search control is configured to display a second page associated with the search control in response to a second trigger operation on the search control.

Optionally, the fourth display module is specifically configured to:
display the search control in the multimedia resource through a preset animation effect, where the
preset animation effect is configured to describe an animation effect of the anchor evolving into the search control.

Optionally, the anchor includes a first image corresponding to the target object, and the preset animation effect includes: the anchor at a first preset position gradually fading away, highlighting the first image through a zoom animation effect, moving the first image to a second preset position, and displaying the search control at the second preset position.

Optionally, the first image is a dynamic image, and the preset animation effect further includes:
controlling the dynamic image to interact with a page element in a display page for displaying the multimedia resource, so as to cause the dynamic image to cooperate with the page element to form a naked-eye three-dimensional effect.

Optionally, the anchor and/or the search control include at least one of a first image corresponding to the target object, a search box, a second image superimposed with the search box, and a search word associated with the target object.

The function logic performed by the various functional modules in the above apparatus for multimedia resource interaction 1000 has been described in detail in the part about the method, and will not be repeated here. Reference is made to FIG. 11 below, which shows a structural schematic diagram of an electronic device (for example, a terminal device) 1100 suitable for implementing embodiments of the present disclosure. The terminal device in the embodiments of the present disclosure may include, but is not limited to, mobile terminals such as a mobile phone, a laptop, a digital broadcast receiver, a personal digital assistant (PDA), a tablet computer (PAD), a portable multimedia player (PMP), a vehicle-mounted terminal (such as a vehicle navigation terminal), and fixed terminals such as a digital TV, a desktop computer, and the like. The electronic device shown in FIG. 11 is only an example, and should not bring any limitation to the functions and usage scopes of the embodiments of the present disclosure.

As shown in FIG. 11, the electronic device 1100 may include a processing apparatus (such as a central processing unit, a graphics processing unit, etc.) 1101, which may perform various appropriate actions and processes according to a program stored in a read-only memory (ROM) 1102 or a program loaded from a storage apparatus 1108 into a random-access memory (RAM) 1103. The RAM 1103 also stores various programs and data required for the operation of the electronic device 1100. The processing apparatus 1101, the ROM 1102, and the RAM 1103 are connected to each other through a bus 1104. An input/output (I/O) interface 1105 is also connected to the bus 1104.

Generally, the following apparatus may be connected to the I/O interface 1105: an input apparatus 1106 including, for example, a touchscreen, a touchpad, a keyboard, a mouse, a camera, a microphone, an accelerometer, a gyroscope, etc.; an output apparatus 1107 including, for example, a liquid crystal display (LCD), a speaker, a vibrator, etc.; the storage apparatus 1108 including, for example, a magnetic tape, a hard disk, etc.; and a communication apparatus 1109. The communication apparatus 1109 may allow the electronic device 1100 to perform wireless or wired communication with other devices to exchange data. Although FIG. 11 shows an electronic device 1100 having various apparatus, it should be understood that it is not required to implement or have all of the illustrated apparatus. More or fewer apparatus may alternatively be implemented or provided.

In particular, according to the embodiments of the present disclosure, the process described above with reference to the flowchart may be implemented as a computer software program. For example, an embodiment of the present disclosure includes a computer program product, which includes a computer program carried on a non-transitory computer-readable medium, and the computer program includes program code for executing the method shown in the flowchart. In such an embodiment, the computer program may be downloaded and installed from the network through the communication apparatus 1109, or installed from the storage apparatus 1108, or installed from the ROM 1102. When the computer program is executed by the processing apparatus 1101, the above functions defined in the method of the embodiment of the present disclosure are executed.

It should be noted that the above computer-readable medium in the present disclosure may be a computer-readable signal medium or a computer-readable storage medium or any combination thereof. The computer-readable storage medium may be, for example, but not limited to, an electronic, magnetic, optical, electromagnetic, infrared, or semiconductor system, apparatus, or device, or any combination thereof. More specific examples of the computer-readable storage medium may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program that can be used by or in combination with an instruction execution system, apparatus, or device. In the present disclosure, the computer-readable signal medium may include a data signal propagated in a baseband or as a part of a carrier wave, in which a computer-readable program code is carried. The data signal propagated in this way may take many forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program code contained in the computer-readable medium may be transmitted by any suitable medium, including but not limited to: an electric wire, an optical cable, a radio frequency (RF), etc., or any suitable combination thereof.

In some implementations, the electronic device may use any currently known or future developed network protocol, such as a HyperText Transfer Protocol (HTTP), to communicate, and may interconnect with digital data communication (for example, communication network) in any form or medium. Examples of communication network include a local area network (“LAN”), a wide area network (“WAN”), an international network (for example, the Internet), and an end-to-end network (for example, ad hoc end-to-end network), as well as any currently known or future developed networks.

The above computer-readable medium may be included in the above electronic device, or may exist alone without being assembled into the electronic device.

The above computer-readable medium carries one or more programs, and when the above one or more programs are executed by the electronic device, the electronic device is caused to: display a multimedia resource, where the multimedia resource includes a target object; display an interactive element associated with the target object in the multimedia resource in response to the multimedia resource being displayed to a display node; and display a page associated with the interactive element in response to a trigger operation on the interactive element.

The computer program code for performing the operations of the present disclosure may be written in one or more programming languages or a combination thereof. The above programming languages include object-oriented programming languages such as Java, Smalltalk, C++, and also include conventional procedural programming languages such as the “C” language or similar programming languages. The program code may be executed entirely on a user's computer, partly on a user's computer, as a stand-alone software package, partly on a user's computer and partly on a remote computer, or entirely on a remote computer or server. In the case of a remote computer, the remote computer may be connected to the user's computer through any kind of network, including a local area network (LAN) or a wide area network (WAN), or may be connected to an external computer (for example, through the Internet using an Internet service provider).

The flowcharts and block diagrams in the drawings illustrate possible architectures, functions, and operations of systems, methods, and computer program products according to various embodiments of the present disclosure. In this regard, each block in the flowcharts or block diagrams may represent a module, a program segment, or a portion of code, which includes one or more executable instructions for implementing a specified logical function. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, may be implemented with a dedicated hardware-based system that performs the specified functions or operations, or may be implemented with a combination of dedicated hardware and computer instructions.

The modules involved in the embodiments of the present disclosure may be implemented in software or hardware. The name of a module does not constitute a limitation on the module itself under certain circumstances.

The functions described herein above may be performed, at least in part, by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The above description is only preferred embodiments of the present disclosure and an illustration of the applied technical principles. Those skilled in the art should understand that the disclosure scope involved in the present disclosure is not limited to the technical solutions formed by the specific combination of the above technical features, and should also cover other technical solutions formed by any combination of the above technical features or their equivalent features without departing from the above disclosed concept, for example, a technical solution formed by replacing the above features with technical features with similar functions disclosed in the present disclosure (but not limited to).

In addition, although operations are depicted in a specific order, this should not be understood as requiring these operations to be performed in the specific order shown or in a sequential order. Under certain circumstances, multitasking and parallel processing may be advantageous. Likewise, although several specific implementation details are included in the above discussion, they should not be construed as limiting the scope of the present disclosure. Certain features that are described in the context of separate embodiments may also be implemented in combination in a single embodiment. Conversely, various features that are described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Rather, the specific features and actions described above are merely exemplary forms of implementing the claims. Regarding the apparatus in the above embodiments, the specific manner in which each module performs operations has been described in detail in the embodiments related to the method, which will not be described in detail here.

1. A method for multimedia resource interaction, comprising:
displaying a multimedia resource, wherein the multimedia resource comprises a target object;
displaying an interactive element associated with the target object in the multimedia resource in response to the multimedia resource being displayed to a display node; and
displaying a page associated with the interactive element in response to a trigger operation on the interactive element.

2. The method according to claim 1, wherein the interactive element comprises an anchor, and the displaying an interactive element associated with the target object in the multimedia resource comprises:
displaying the anchor in the multimedia resource; and
the displaying a page associated with the interactive element in response to a trigger operation on the interactive element comprises:
displaying a first page associated with the anchor in response to a first trigger operation on the anchor.

3. The method according to claim 2, further comprising:
displaying a search control associated with the target object in the multimedia resource in response to not detecting the first trigger operation on the interactive element, wherein the search control is configured to display a second page associated with the search control in response to a second trigger operation on the search control.

4. The method according to claim 3, wherein the displaying a search control associated with the target object in the multimedia resource comprises:
displaying the search control in the multimedia resource through a preset animation effect, wherein the preset animation effect is configured to describe an animation effect of the anchor evolving into the search control.

5. The method according to claim 4, wherein the anchor comprises a first image corresponding to the target object, and
the preset animation effect comprises: the anchor at a first preset position gradually fading away, highlighting the first image through a zoom animation effect, moving the first image to a second preset position, and displaying the search control at the second preset position.

6. The method according to claim 5, wherein the first image is a dynamic image, and the preset animation effect further comprises:
controlling the dynamic image to interact with a page element in a display page for displaying the multimedia resource, so as to cause the dynamic image to cooperate with the page element to form a naked-eye three-dimensional effect.

7. The method according to claim 3, wherein the anchor and/or the search control comprise at least one of a group consisting of a first image corresponding to the target object, a search box, a second image superimposed with the search box, and a search word associated with the target object.

8. The method according to claim 4, wherein the anchor and/or the search control comprise at least one of a group consisting of a first image corresponding to the target object, a search box, a second image superimposed with the search box, and a search word associated with the target object.

9. The method according to claim 5, wherein the anchor and/or the search control comprise at least one of a group consisting of a first image corresponding to the target object, a search box, a second image superimposed with the search box, and a search word associated with the target object.

10. The method according to claim 6, wherein the anchor and/or the search control comprise at least one of a group consisting of a first image corresponding to the target object, a search box, a second image superimposed with the search box, and a search word associated with the target object.

11. A non-transitory computer-readable storage medium, storing computer programs, wherein the computer programs, upon being executed by a processor, implement a method for multimedia resource interaction, wherein the method comprises:
displaying a multimedia resource, wherein the multimedia resource comprises a target object;
displaying an interactive element associated with the target object in the multimedia resource in response to the multimedia resource being displayed to a display node; and
displaying a page associated with the interactive element in response to a trigger operation on the interactive element.

12. An electronic device, comprising:
at least one memory, storing computer programs; and
at least one processor, configured to execute the computer programs in the at least one memory to implement a method for multimedia resource interaction, wherein the method comprises:
displaying a multimedia resource, wherein the multimedia resource comprises a target object;
displaying an interactive element associated with the target object in the multimedia resource in response to the multimedia resource being displayed to a display node; and
displaying a page associated with the interactive element in response to a trigger operation on the interactive element.

13. The electronic device according to claim 12, wherein the interactive element comprises an anchor, and the displaying an interactive element associated with the target object in the multimedia resource comprises:
displaying the anchor in the multimedia resource; and
the displaying a page associated with the interactive element in response to a trigger operation on the interactive element comprises:
displaying a first page associated with the anchor in response to a first trigger operation on the anchor.

14. The electronic device according to claim 13, wherein the method further comprises:
displaying a search control associated with the target object in the multimedia resource in response to not detecting the first trigger operation on the interactive element, wherein the search control is configured to display a second page associated with the search control in response to a second trigger operation on the search control.

15. The electronic device according to claim 14, wherein the displaying a search control associated with the target object in the multimedia resource comprises:
displaying the search control in the multimedia resource through a preset animation effect, wherein the preset animation effect is configured to describe an animation effect of the anchor evolving into the search control.

16. The electronic device according to claim 15, wherein the anchor comprises a first image corresponding to the target object,
and the preset animation effect comprises: the anchor at a first preset position gradually fading away, highlighting the first image through a zoom animation effect, moving the first image to a second preset position, and displaying the search control at the second preset position.

17. The electronic device according to claim 16, wherein the first image is a dynamic image, and the preset animation effect further comprises:
controlling the dynamic image to interact with a page element in a display page for displaying the multimedia resource, so as to cause the dynamic image to cooperate with the page element to form a naked-eye three-dimensional effect.

18. The electronic device according to claim 14, wherein the anchor and/or the search control comprise at least one of a group consisting of a first image corresponding to the target object, a search box, a second image superimposed with the search box, and a search word associated with the target object.

19. The electronic device according to claim 15, wherein the anchor and/or the search control comprise at least one of a group consisting of a first image corresponding to the target object, a search box, a second image superimposed with the search box, and a search word associated with the target object.

20. The electronic device according to claim 16, wherein the anchor and/or the search control comprise at least one of a group consisting of a first image corresponding to the target object, a search box, a second image superimposed with the search box, and a search word associated with the target object.
